(19) United States
(12) Patent Application Publication
(10) Pub. No.: US 2013/0060584 A1
(43) Pub. Date: Mar. 7, 2013

(54) SYSTEMS AND METHODS FOR CUSTOMER-DRIVEN RISK ANALYSIS

(71) Applicants: Amy Balthazar, Manchester, CT (US); Michael Strietelmeier, Enfield, CT (US)

(72) Inventors: Amy Balthazar, Manchester, CT (US); Michael Strietelmeier, Enfield, CT (US)

(73) Assignee: The Travelers Indemnity Company, Hartford, CT (US)

(21) Appl. No.: 13/459,503

(22) Filed: Apr. 30, 2012

Related U.S. Application Data
(63) Continuation-in-part of application No. 13/225,366, filed on Sep. 2, 2011.

(51) Int. Cl. G06Q 40/08

(52) U.S. Cl. 705/4

(57) ABSTRACT

Systems, methods, and articles of manufacture (such as interfaces) may be provided to enable a customer to identify, manage, reduce, and/or otherwise analyze or determine risk exposure.

### CROSS-REFERENCE TO RELATED APPLICATIONS

This application claims benefit and priority to, and is a Continuation-In-Part (CIP) of, U.S. patent application Ser. No. 13/225,366 filed on Sep. 2, 2011 and titled “SYSTEMS AND METHODS FOR INSURANCE PRODUCT PRICING AND SAFETY PROGRAM MANAGEMENT”, the entirety of which is hereby incorporated by reference herein.

### BACKGROUND

Risk analysis is typically a specialized and highly sought-after skill. In the insurance context, for example, business insurance customers typically pay for risk analysis specialists to conduct reviews and assessments of their business risk exposure. The specialists often analyze volumes of data to determine what practices of a business might be altered to reduce risk, loss, and/or insurance costs. Without the knowledge and training of such specialists, the typical individual or entity has little chance of developing strategies or procedures that are likely to reduce risk exposure.

### BRIEF DESCRIPTION OF THE DRAWINGS

An understanding of embodiments described herein and many of the attendant advantages thereof may be readily obtained by reference to the following detailed description when considered with the accompanying drawings, wherein:

FIG. 1 is a block diagram of a system according to some embodiments;

FIG. 2 is a block diagram of a system according to some embodiments

FIG. 3A and FIG. 3B are diagrams of an example data storage structure according to some embodiments;

FIG. 4 is a flow diagram of a method according to some embodiments;

FIG. 5A, FIG. 5B, FIG. 5C, FIG. 5D, FIG. 5E, FIG. 5F, FIG. 5G, FIG. 5H, and FIG. 5I are example interfaces according to some embodiments;

FIG. 6 is a block diagram of an apparatus according to some embodiments; and

FIG. 7A, FIG. 7B, FIG. 7C, and FIG. 7D are perspective diagrams of exemplary data storage devices according to some embodiments.

### DETAILED DESCRIPTION

Embodiments presented herein are descriptive of systems, apparatus, methods, and articles of manufacture for customer-driven risk analysis. In some embodiments, for example, an interface or “dashboard” may be provided that allows a customer to identify, manage, remediate, and/or otherwise process or analyze risk exposure associated with the customer.

As utilized herein, the term “customer” may generally refer to any type, quantity, and or manner of entity for which (or by which) risk can be estimated, quantified, calculated, predicted, identified, and/or otherwise determined. A customer may comprise a business insurance policy holder, for example, and/or may comprise another entity that seeks to determine risk exposure and/or price and/or obtain an insurance and/or other underwriting product and/or policy. A customer may have an existing business relationship with other entities described herein, such as an insurance company for example, or may not yet have such a relationship—i.e., a “customer” may comprise a “potential customer” (e.g., in general and/or with respect to a specific product offering). In some embodiments, a customer may comprise a user of an interface (e.g., whether or not such a user conducts a purchase or seeks to conduct a purchase). A user may comprise, for example, an agent, underwriter, and/or other employee or personnel of an entity seeking to analyze, determine, and/or manage risk exposure (risk exposure of themselves and/or risk exposure of another entity, customer, user, etc.), such as a consultant and/or insurer, for example.

Some embodiments described herein are associated with a “customer device” or a “network device”. As used herein, a “customer device” is a subset of a “network device”. The “network device”, for example, may generally refer to any device that can communicate via a network, while the “customer device” may comprise a network device that is owned or operated by or otherwise associated with a customer. Examples of customer and/or network devices may include, but are not limited to: a Personal Computer (PC), a computer workstation, a computer server, a printer, a scanner, a facsimile machine, a copier, a Personal Digital Assistant (PDA), a storage device (e.g., a disk drive), a hub, a router, a switch, and a modem, a video game console, or a wireless or cellular telephone. Customer and/or network devices may comprise one or more network components

As used herein, the term “network component” may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network.” As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration or type that is or becomes known. Communication networks may include, for example, devices that communicate directly or indirectly, via a wired or wireless medium such as the Internet, intranet, a Local Area Network (LAN), a Wide Area Network (WAN), a cellular telephone network, a Bluetooth® network, a Near-Field Communication (NFC) network, a Radio Frequency (RF) network, a Virtual Private Network (VPN), Ethernet (or IEEE 802.3), Token Ring, or via any appropriate communications means or combination of communications means. Exemplary protocols include but are not limited to: Bluetooth™, Time Division Multiple Access (TDMA), Code Division Multiple Access (CDMA), Global System for Mobile communications (GSM), Enhanced Data rates for GSM Evolution (EDGE), General Packet Radio Service (GPRS), Wideband CDMA (WCDMA), Advanced Mobile Phone System (AMPS), Digital AMPS (D-AMPS), IEEE 802.11 (WI-FI), IEEE 802.3, SAP, the best of breed (BOB), and/or system to system (S2S).

In cases where video signals or large files are being sent over the network, a broadband network may be used to alleviate delays associated with the transfer of such large files, however, such an arrangement is not required. Each of the devices may be adapted to communicate on such a communication means. Any number and type of machines may be in communication via the network. Where the network is the Internet, communications over the Internet may be through a website maintained by a computer on a remote server or over an online data network, including commercial online service providers, and/or bulletin board systems. In yet other embodiments, the devices may communicate with one another over RF, cable TV, and/or satellite links. Where appropriate, encryption or other security measures, such as logins and passwords, may be provided to protect proprietary or confidential information.

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard. Information may, according to some embodiments, be compressed, encoded, encrypted, and/or otherwise packaged or manipulated in accordance with any method that is or becomes known or practicable.

As used herein, “determining” includes calculating, computing, deriving, looking up (e.g., in a table, database, or data structure), ascertaining, and/or recognizing.

A “processor” means any one or more microprocessors, Central Processing Unit (CPU) devices, computing devices, microcontrollers, and/or digital signal processors. As utilized herein, the term “computerized processor” generally refers to any type or configuration of primarily non-organic processing device that is or becomes known. Such devices may include, but are not limited to, computers, Integrated Circuit (IC) devices, CPU devices, logic boards and/or chips, Printed Circuit Board (PCB) devices, electrical or optical circuits, switches, electronics, optics and/or electrical traces. A sub-class of computerized processors, as utilized herein, may comprise “mechanical processors” which may generally include, but are not limited to, mechanical gates, mechanical switches, cogs, wheels, gears, flywheels, cams, mechanical timing devices, etc.

The terms “computer-readable medium” and “computer-readable memory” refer to any medium that participates in providing data (e.g., instructions) that may be read by a computer and/or a processor. Such a medium may take many forms, including but not limited to non-volatile media, volatile media, and other specific types of transmission media. Non-volatile media include, for example, optical or magnetic disks and other persistent memory. Volatile media include DRAM, which typically constitutes the main memory. Other types of transmission media include coaxial cables, copper wire, and fiber optics, including the wires that comprise a system bus coupled to the processor.

Common forms of computer-readable media include, for example, a floppy disk, a flexible disk, hard disk, magnetic tape, any other magnetic medium, a CD-ROM, Digital Video Disc (DVD), any other optical medium, punch cards, paper tape, any other physical medium with patterns of holes, a RAM, a PROM, an EPROM, a FLASH-EEPROM, a USB memory stick, a dongle, any other memory chip or cartridge, a carrier wave, or any other medium from which a computer can read. The terms “computer-readable medium” and/or “tangible media” specifically exclude signals, waves, and wave forms or other intangible or transitory media that may nevertheless be readable by a computer.

Various forms of computer-readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols. For a more exhaustive list of protocols, the term “network” is defined above and includes many exemplary protocols that are also applicable here.

In some embodiments, one or more specialized machines such as a computerized processing device, a server, a remote terminal, and/or a customer device may implement the various practices described herein. A computer system of an insurance company may, for example, comprise various specialized computers that interact to perform risk assessments, insurance premium calculations, and/or insurance product sales as described herein.

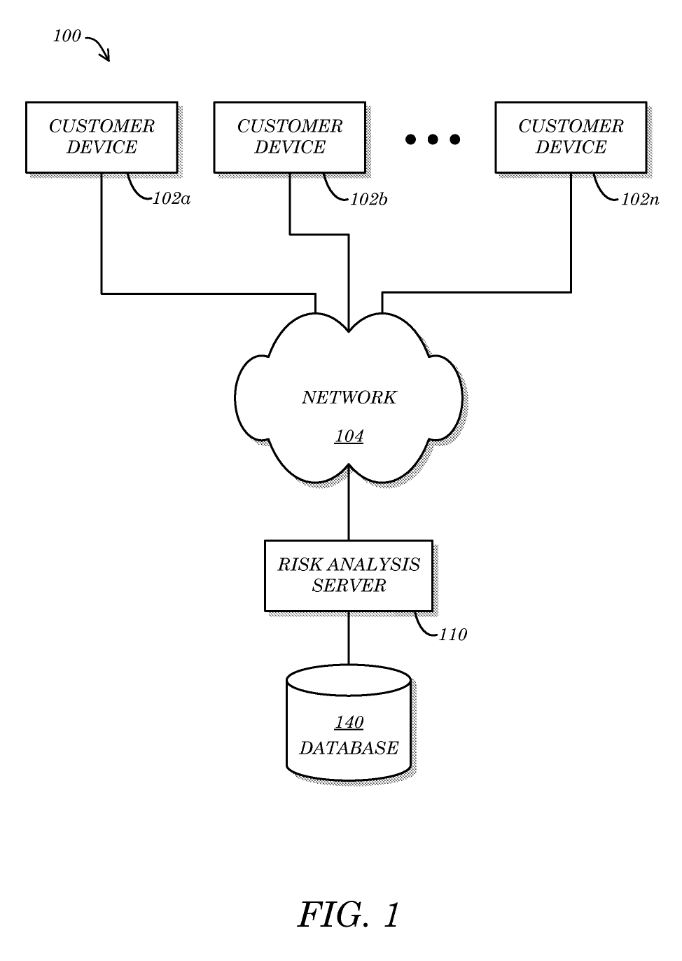

Turning first to FIG. 1, a block diagram of a system 100 according to some embodiments is shown. In some embodiments, the system 100 may comprise a plurality of customer devices 102a-n in communication with and/or via a network 104. In some embodiments, a risk analysis server 110 may be in communication with the network 104 and/or one or more of the customer devices 102a-n. In some embodiments, the risk analysis server 110 (and/or the customer devices 102a-n) may be in communication with a database 140. The database 140 may store, for example, risk data associated with customers owning and/or operating the customer devices 102a-n, and/or instructions that cause various devices (e.g., the risk analysis server 110 and/or the customer devices 102a-n) to operate in accordance with embodiments described herein.

The customer devices 102a-n, in some embodiments, may comprise any type or configuration of electronic, mobile electronic, and or other network and/or communication devices (or combinations thereof) that are or become known or practicable. The first customer device 102a may, for example, comprise one or more PC devices, computer workstations (e.g., underwriter workstations), tablet computers, such as an iPad® manufactured by Apple®, Inc. of Cupertino, Calif., and/or cellular and/or wireless telephones such as an iPhone® (also manufactured by Apple®, Inc.) or an Optimus™ S smart phone manufactured by LG® Electronics, Inc. of San Diego, Calif., and running the Android® operating system from Google®, Inc. of Mountain View, Calif. In some embodiments, one or more of the customer devices 102a-n may be specifically utilized and/or configured (e.g., via specially-programmed and/or stored instructions such as may define or comprise a software application) to communicate with the risk analysis server 110 (e.g., via the network 104).

The network 104 may, according to some embodiments, comprise LAN, WAN, cellular telephone network, Bluetooth® network, NFC network, and/or RF network with communication links between the customer devices 102a-n, the risk analysis server 110, and/or the database 140. In some embodiments, the network 104 may comprise direct communications links between any or all of the components 102a-n, 110, 140 of the system 100. The risk analysis server 110 may, for example, be directly interfaced or connected to the database 140 via one or more wires, cables, wireless links, and/or other network components, such network components (e.g., communication links) comprising portions of the network 104. In some embodiments, the network 104 may comprise one or many other links or network components other than those depicted in FIG. 1. The second customer device 102b may, for example, be connected to the risk analysis server 110 via various cell towers, routers, repeaters, ports, switches, and/or other network components that comprise the Internet and/or a cellular telephone (and/or Public Switched Telephone Network (PSTN)) network, and which comprise portions of the network 104.

While the network 104 is depicted in FIG. 1 as a single object, the network 104 may comprise any number, type, and/or configuration of networks that is or becomes known or practicable. According to some embodiments, the network 104 may comprise a conglomeration of different sub-networks and/or network components interconnected, directly or indirectly, by the components 102a-n, 110, 140 of the system 100. The network 104 may comprise one or more cellular telephone networks with communication links between the customer devices 102a-n and the risk analysis server 110, for example, and/or may comprise the Internet, with communication links between the customer devices 102a-n and the database 140, for example.

According to some embodiments, the risk analysis server 110 may comprise a device (or system) owned and/or operated by or on behalf of or for the benefit of an insurance company. The insurance company may utilize customer information (e.g., customer risk exposure data), in some embodiments, to manage, analyze, design, rate, price, and/or otherwise structure insurance products. In some embodiments, the insurance company (and/or a third-party, not explicitly shown) may provide an interface (not shown in FIG. 1) to and/or via the customer devices 102a-n. The interface may be configured, according to some embodiments, to allow and/or facilitate management, analysis, and/or other processing of risk data by one or more customers. In some embodiments, the system 100 (and/or interface provided by the risk analysis server 110) may present risk data (e.g., from the database 140) in such a manner that allows customers to make informed risk analysis, risk exposure, and/or risk remediation decisions.

In some embodiments, the database 140 may comprise any type, configuration, and/or quantity of data storage devices that are or become known or practicable. The database 140 may, for example, comprise an array of optical and/or solid-state hard drives configured to store customer and/or risk data, and/or various operating instructions, drivers, etc. While the database 140 is depicted as a stand-alone component of the system 100 in FIG. 1, the database 140 may comprise multiple components. In some embodiments, a multi-component database 140 may be distributed across various devices and/or may comprise remotely dispersed components. Any or all of the customer devices 102a-n may comprise the database 140 or a portion thereof, for example, and/or the risk analysis server 110 may comprise the database 140 or a portion thereof.

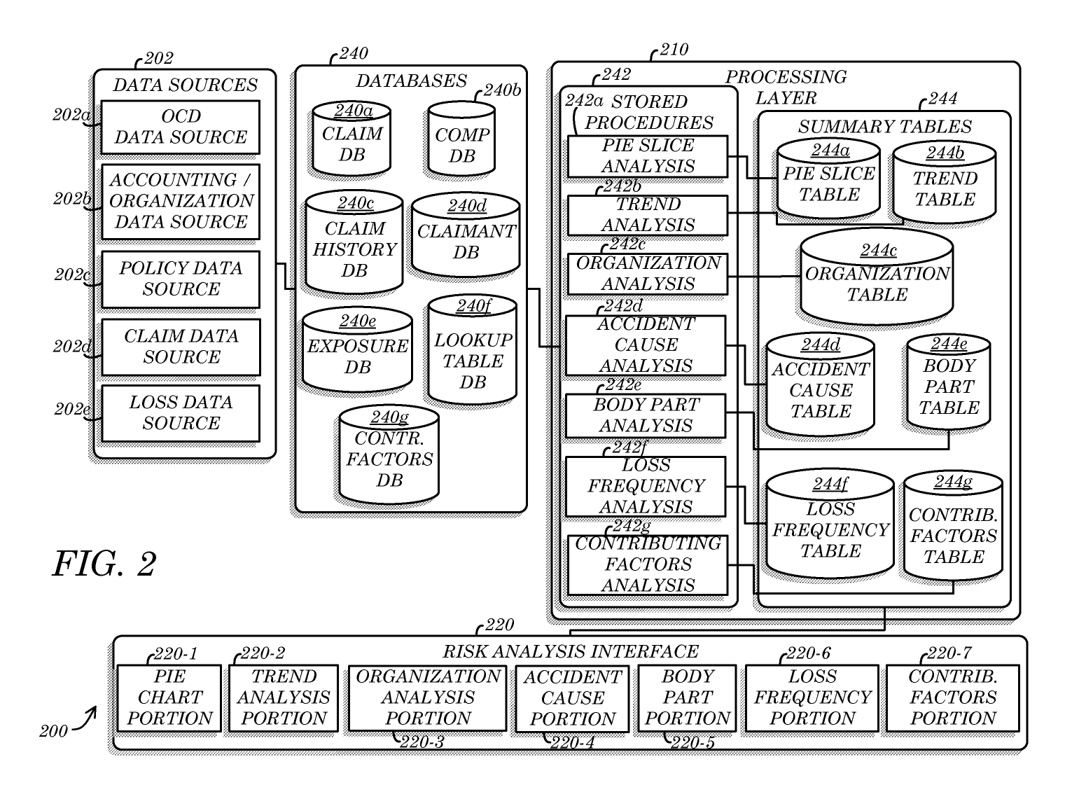

Referring now to FIG. 2, a block diagram of a system 200 according to some embodiments is shown. In some embodiments, the system 200 may comprise a plurality of data sources 202, a processing layer 210, a risk analysis interface 220, and/or a plurality of databases 240. In some embodiments, the system 200 and/or the processing layer 210 may comprise a plurality of stored procedures 242 and/or a plurality of summary tables 244. According to some embodiments, any or all of the components 202, 210, 220, 240, 242, 244 of the system 200 may be similar in configuration and/or functionality to any similarly named and/or numbered components described herein. Fewer or more components 202, 210, 220, 240, 242, 244 (and/or portions thereof) and/or various configurations of the components 202, 210, 220, 240, 242, 244 may be included in the system 200 without deviating from the scope of embodiments described herein. While multiple instances of some 202, 210, 220, 240, 242, 244 are depicted and while single instances of other components 202, 210, 220, 240, 242, 244 are depicted, for example, any component 202, 210, 220, 240, 242, 244 depicted in the system 200 may comprise a single device, a combination of devices and/or components 202, 210, 220, 240, 242, 244, and/or a plurality of devices, as is or becomes desirable and/or practicable. Similarly, in some embodiments, one or more of the various components 202, 210, 220, 240, 242, 244 may not be needed and/or desired in the system 200.

According to some embodiments, any or all of the data sources 202 may be coupled to, configured to, oriented to, and/or otherwise disposed to provide and/or communicate data to one or more of the databases 240. A third-party data source 202a (e.g., an Other Carrier Data (OCD) source), an Accounting/Organization data source 202b, a Policy data source 202c, a Claim data source 202d, and/or a Loss data source 202e may, for example, provide data that may be fed into one or more of a Claim database 240a, a Workers' Compensation (e.g. “Comp”) database 240b, a Claim History database 240c, a Claimant database 240d, an Exposure database 240e, a Lookup Table database 240f, and/or a Contributing Factors database 240g. In some embodiments, the data from the data sources 202a-e may comprise risk, insurance, and/or other data descriptive of, assigned to, and/or otherwise associated with a customer (or group of customers).

In some embodiments, the data stored in any or all of the databases 240a-g may be utilized by the processing layer 210. The processing layer 210 may, for example, execute and/or initiate one or more of the stored procedures 242 to process the data in the databases 240a-g (or one or more portions thereof) and/or to define one or more of the summary tables 244. In some embodiments, the stored procedures 242 may comprise one or more of a pie slice analysis 242a, a trend analysis 242b, an organization analysis 242c, an accident cause analysis 242d, a body part analysis 242e, a loss frequency analysis 242f, and/or a contributing factors analysis 242g. According to some embodiments, the summary tables 244 may comprise a pie slice table 244a, a trend table 244b, an organization table 244c, an accident cause table 244d, a body part table 244e, a loss frequency table 244f, and/or a contributing factors table 244g. In some embodiments, the processing layer 210 may execute, facilitate, and/or be otherwise associated with one or more mapping processes. In the example case of business insurance injury types, such as workers' compensation injury types known in the industry, the lookup table database 240f may store pre-defined mappings of injury types to injury classifications and/or the accident cause analysis 242d and/or the body part analysis 242e may store instructions mapping known injury types to injury classifications. For example, different types of strain injuries may be classified as “ergonomic injuries”—e.g., types of injuries likely to have been caused by poor and/or improper ergonomics in the workplace. In some embodiments, application of pre-defined mappings to stored data may be utilized to produce and/or populate one or more of the summary tables 244a-g such as the accident cause summary table 244d and/or the body part summary table 244e.

According to some embodiments, the execution of the stored procedures 242a-g may define, identify, calculate, create, and/or otherwise determine one or more of the summary tables 244a-g. In some embodiments, one or more of the summary tables 244a-g may be utilized to provide the risk analysis interface 220. According to some embodiments, each summary table 244a-g may drive, power, define, support, underlie, and/or otherwise determine each of a plurality of portions of the risk analysis interface 220. A first and/or pie chart portion 220-1 of the risk analysis interface 220 may display data from the pie slice table 244a, for example, a second and/or trend analysis portion 220-2 of the risk analysis interface 220 may display data from the trend table 244b, a third and/or organization analysis portion 220-3 of the risk analysis interface 220 may display data from the organization table 244c, a fourth and/or accident cause portion 220-4 of the risk analysis interface 220 may display data from the accident cause table 244d, a fifth and/or body part portion 220-5 of the risk analysis interface 220 may display data from the body part table 244e, a sixth and/or loss trend portion 220-6 of the risk analysis interface 220 may display data from the loss frequency table 244f, and/or a seventh and/or contributing factors portion 220-7 of the risk analysis interface 220 may display data from the contributing factors table 244g.

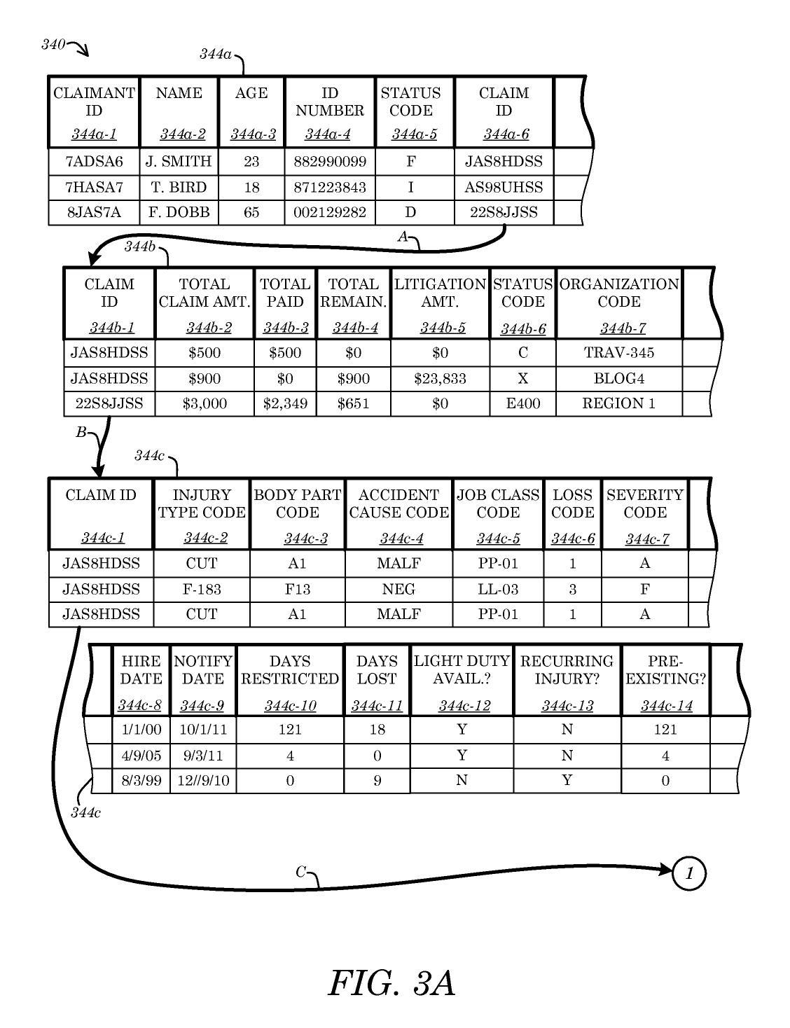

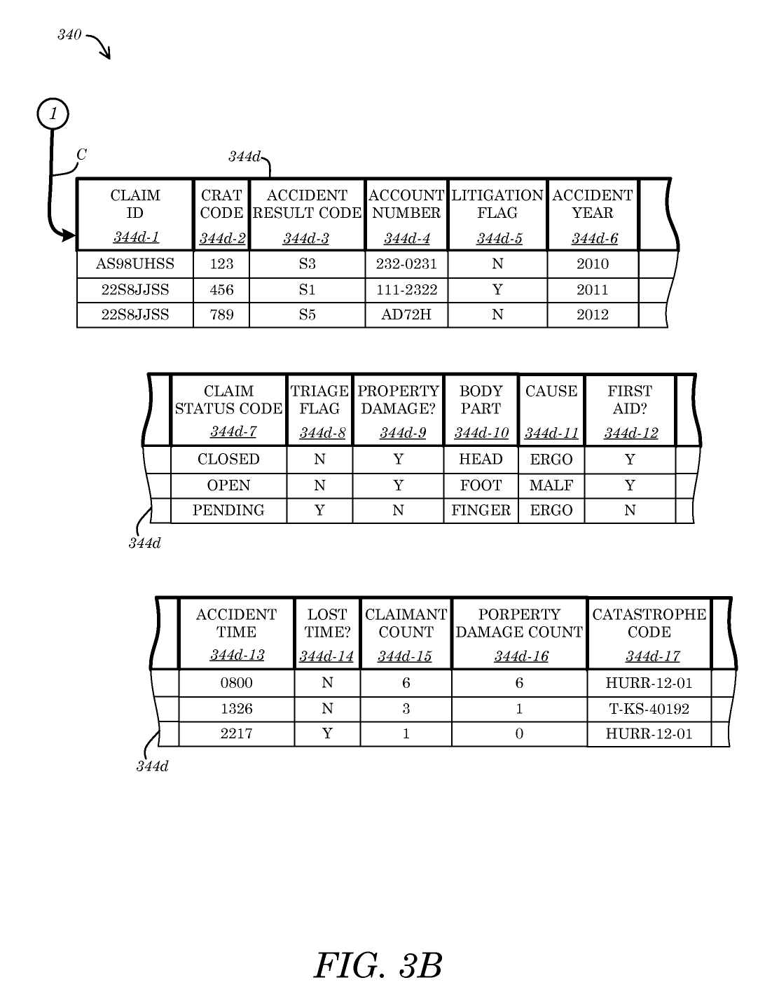

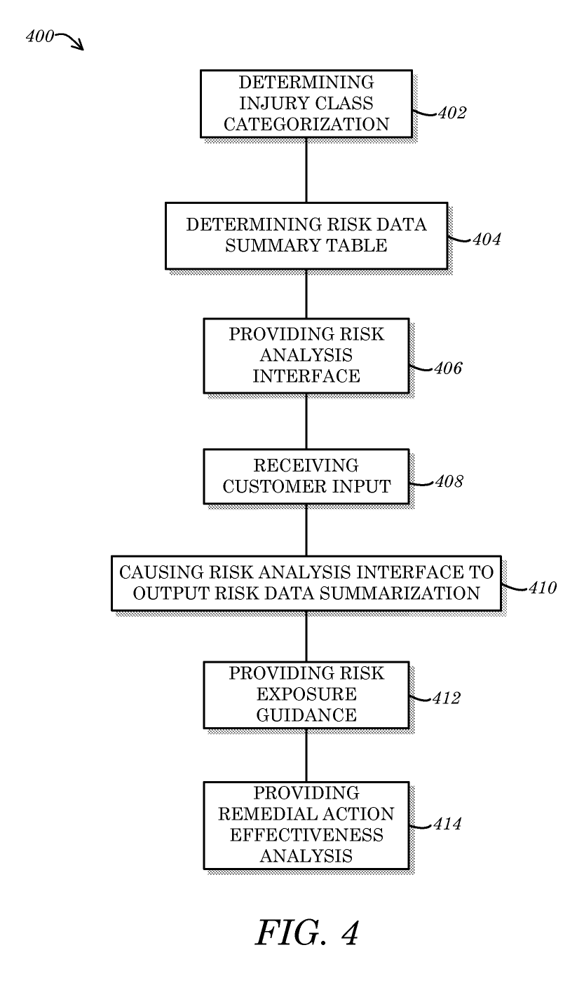

Referring to FIG. 3A and FIG. 3B, diagrams of an example data storage structure 340 according to some embodiments are shown. In some embodiments, the data storage structure 340 may comprise a plurality of data tables such as a claimant table 344a, a claim history table 344b, an exposure table 344c, and/or a claims table 344d. The data tables 344a-d may, for example, be utilized (e.g., at 404 of the method 400 of FIG. 4) to determine, define, calculate, define, and/or provide a customer-driven risk analysis interface as described herein.

The claimant table 344a may comprise, in accordance with some embodiments, a claimant IDentifier (ID) field 344a-1, a name field 344a-2, an age field 344a-3, an ID number field 344a-4, a status code field 344a-5, and/or a claim ID field 344a-6. Any or all of the ID fields 344a-1-344a-6 may generally store any type of identifier that is or becomes desirable or practicable (e.g., a unique identifier, an alphanumeric identifier, and/or an encoded identifier).

The claim history table 344b may comprise, in accordance with some embodiments, a claim ID field 344b-1, a total claim amount field 344b-2, a total paid field 344b-3, a total remaining field 344b-4, a litigation amount field 344b-5, a status code field 344b-6, and/or an organization field 344b-7. The exposure table 344c may comprise, in accordance with some embodiments, a claim ID field 344c-1, a an injury type code field 344c-2, a body part code field 344c-3, an accident cause code field 344c-4, a job class code field 344c-5, a loss code field 344c-6, a severity code field 344c-7, a hire date field 344c-8, a notify date field 344c-9, a days restricted field 344c-10, a days lost field 344c-11, a light duty availability field 344c-12, a recurring injury field 344c-13, and/or a pre-existing condition field 344c-14.

The claims table 344d may comprise, in accordance with some embodiments, a claim ID field 344d-1, an accident code field 344d-2, an accident result code field 344d-3, an account number field 344d-4, a litigation flag field 344d-5, an accident year field 344d-6, a claim status code field 344d-7, a triage flag field 344d-8, a property damage field 344d-9, a body part field 344d-10, a cause field 344d-11, a first aid field 344d-12, an accident time field 344d-13, a lost time field 344d-14, a claimant count field 344d-15, a property damage count field 344d-16, and/or a catastrophe code field 344d-17.

In some embodiments, risk summary data may be defined by relationships established between two or more of the data tables 344a-d. As depicted in the example data storage structure 340, for example, a first relationship “A” may be established between the claimant table 344a and the claim history table 344b. In some embodiments (e.g., as depicted in FIG. 3A), the first relationship “A” may be defined by utilizing the claim ID field 344a-6 as a data key linking to the claim ID field 344b-1. According to some embodiments, the first relationship “A” may comprise any type of data relationship that is or becomes desirable, such as a one-to-many, many-to-many, or many-to-one relationship.

According to some embodiments, a second relationship “B” may be established between the claim history table 344b and the exposure table 344c. In some embodiments (e.g., as depicted in FIG. 3A), the second relationship “B” may be defined by utilizing the claim ID field 344b-1 as a data key linking to the claim ID field 344c-1. According to some embodiments, the second relationship “B” may comprise any type of data relationship that is or becomes desirable, such as a one-to-many, many-to-many, or many-to-one relationship.

In some embodiments, a third relationship “C” may be established between the exposure table 344c and the claims table 344d. In some embodiments (e.g., as depicted in FIG. 3A and FIG. 3B), the third relationship “C” may be defined by utilizing the claim ID field 344c-1 as a data key linking to the claim ID field 344d-1. According to some embodiments, the third relationship “C” may comprise any type of data relationship that is or becomes desirable, such as a one-to-many, many-to-many, or many-to-one relationship

Utilizing the first, second, and/or third relationships, “A”, “B”, and/or “C”, it may accordingly be possible to provide a risk analysis interface that may be utilized by a customer to determine risk exposure metrics.

In some embodiments, fewer or more data fields than are shown may be associated with the data tables 344a-d. Only a portion of one or more databases and/or other data stores is necessarily shown in any of FIG. 3A and/or FIG. 3B, for example, and other database fields, columns, structures, orientations, quantities, and/or configurations may be utilized without deviating from the scope of some embodiments. Further, the data shown in the various data fields is provided solely for exemplary and illustrative purposes and does not limit the scope of embodiments described herein.

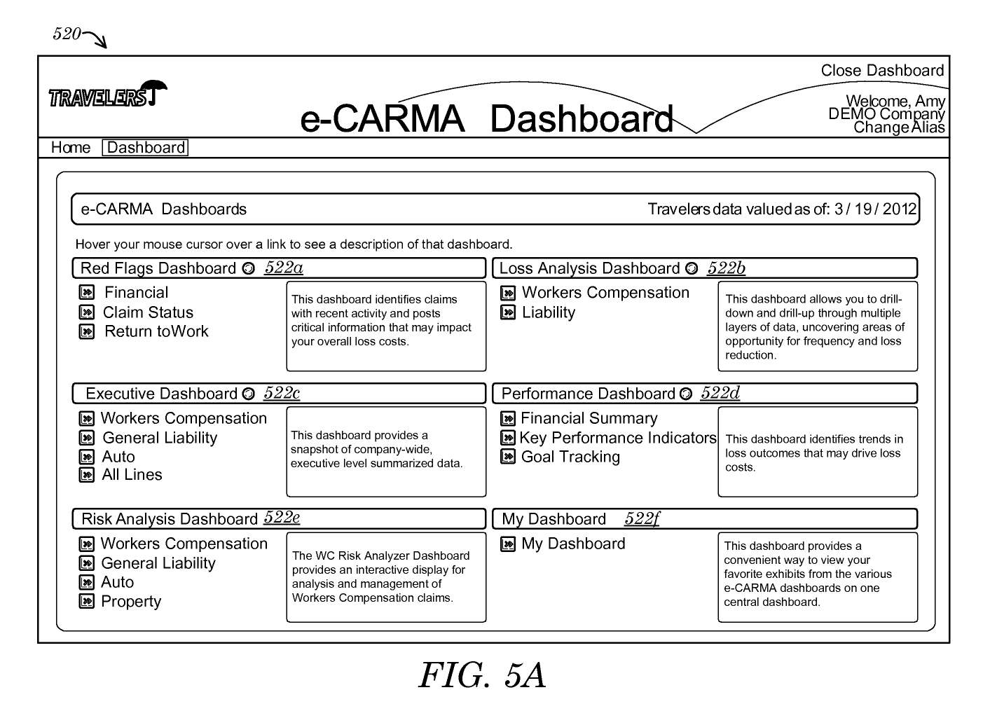

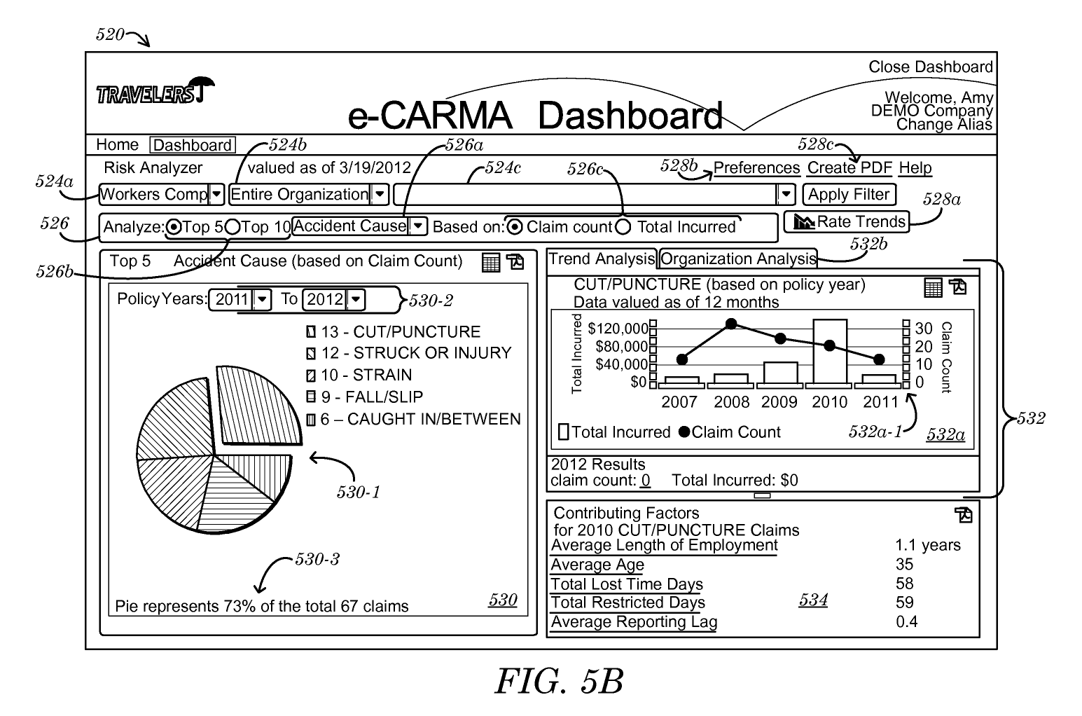

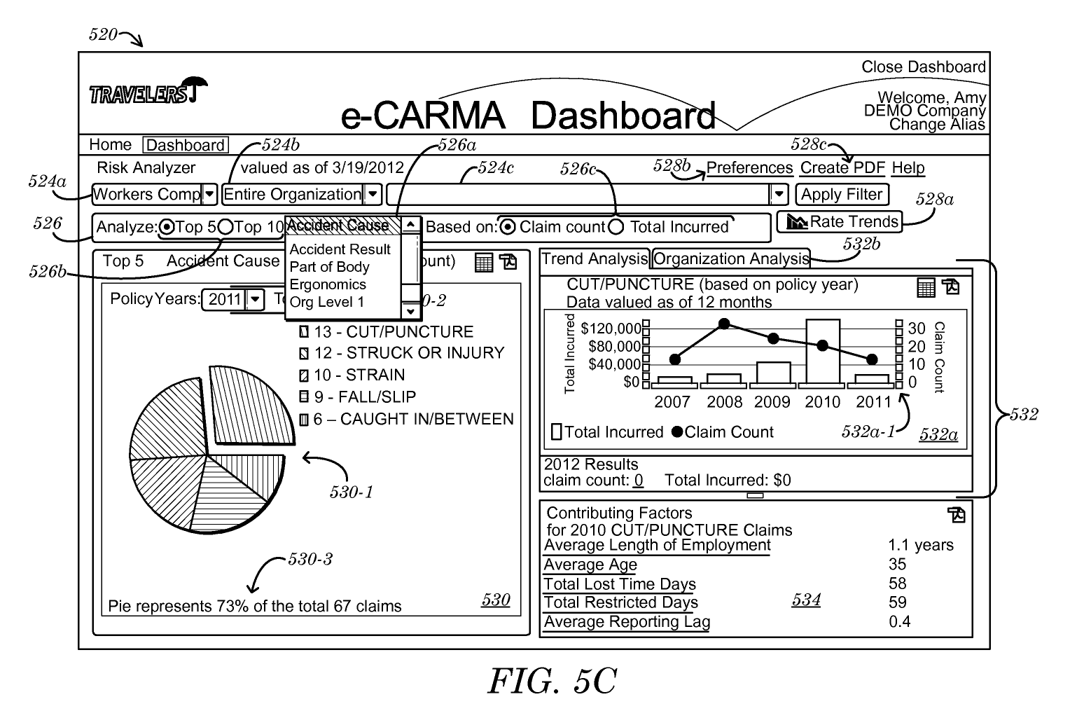

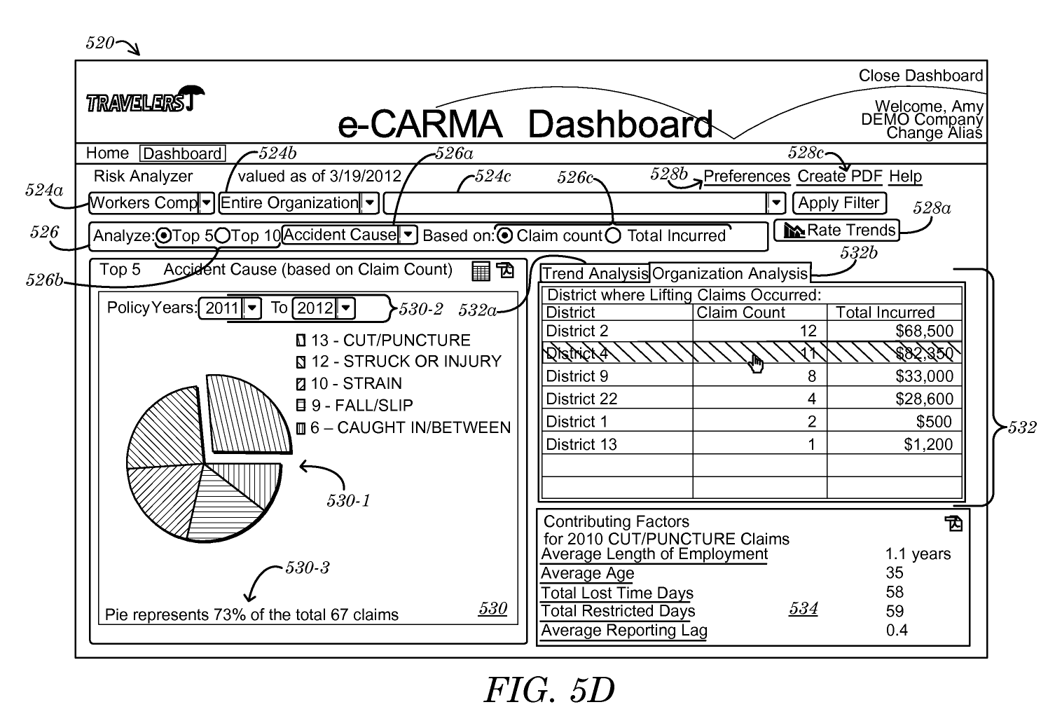

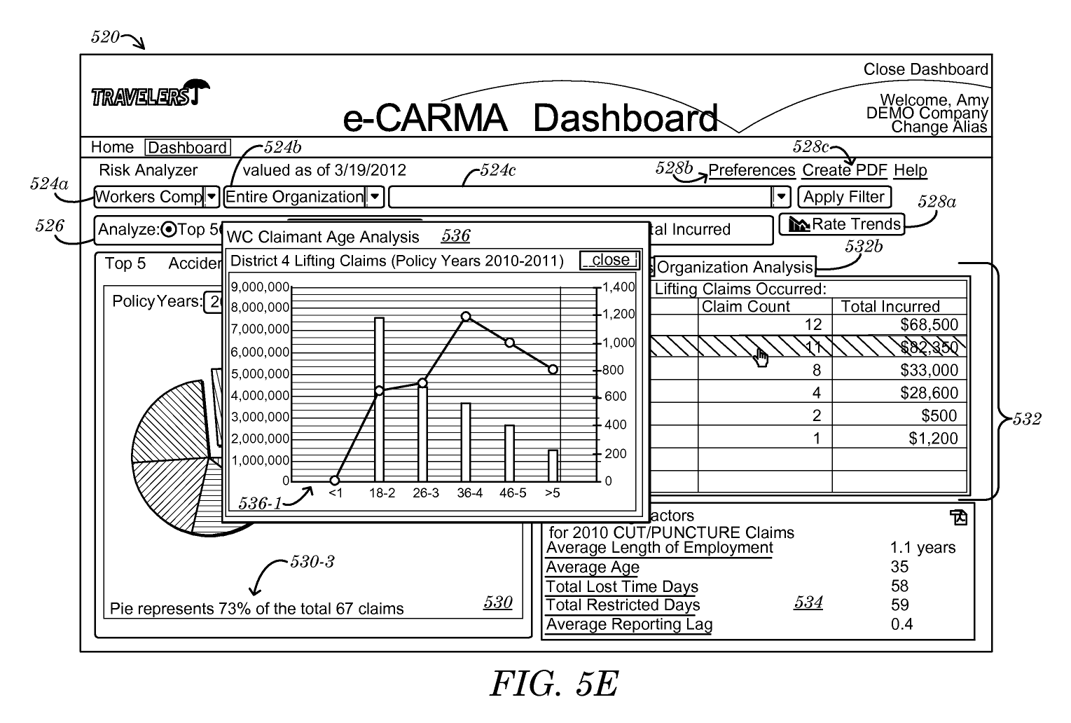

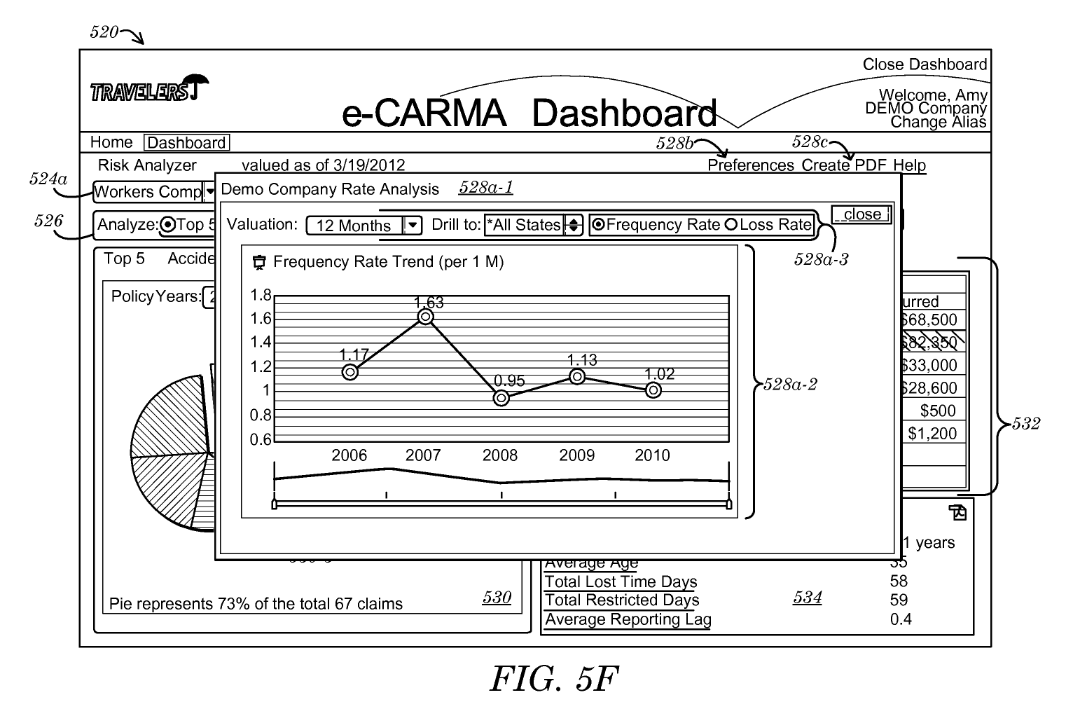

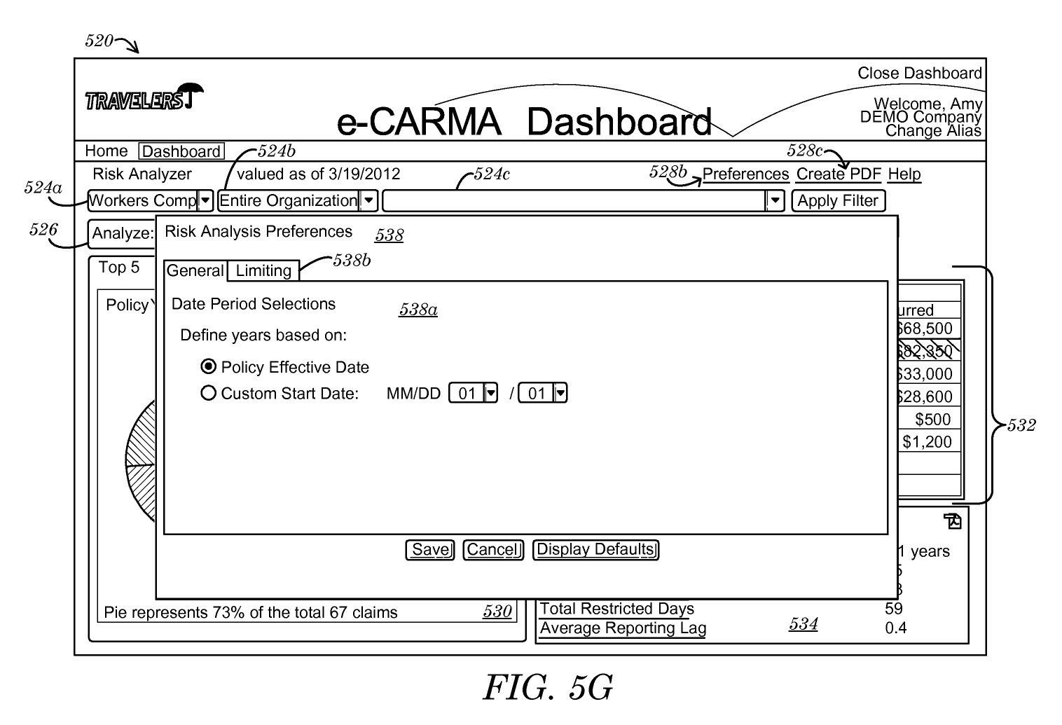

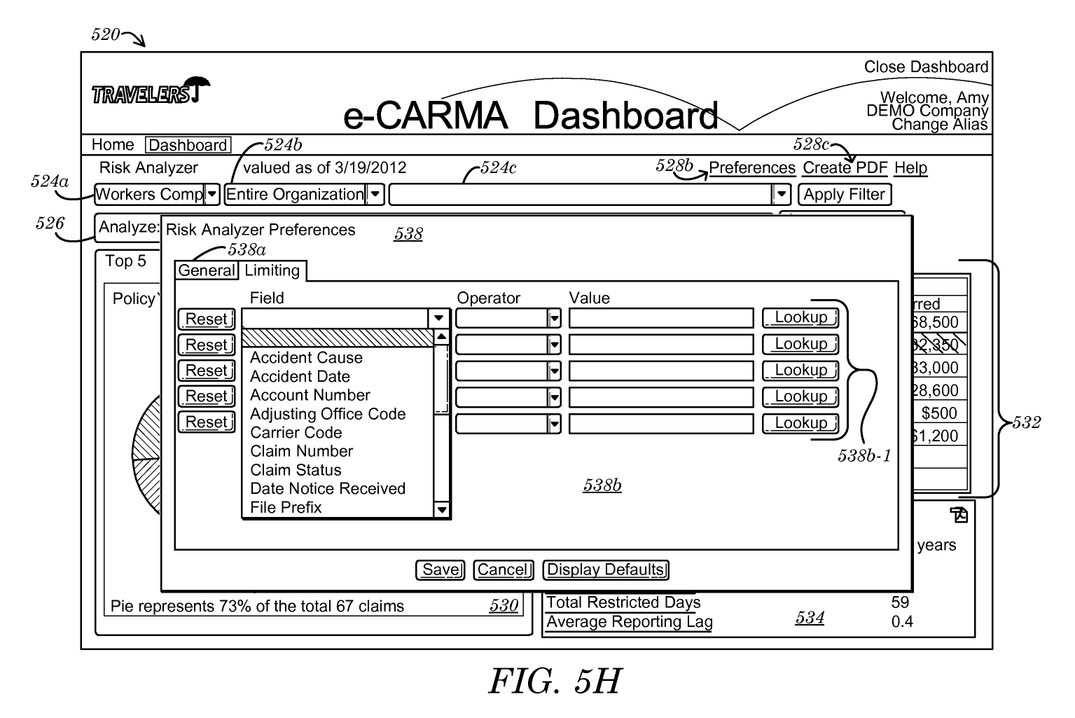

Turning to FIG. 4, a flowchart of a method 400 according to some embodiments is shown. In some embodiments, the method 400 may be performed and/or implemented by and/or otherwise associated with one or more specialized computerized processing devices, computers, computer terminals, and/or computer servers (e.g., the risk analysis server 110 of FIG. 1 and/or the processing layer 210 of FIG. 2), computer systems (e.g., the systems 100, 200 of FIG. 1 and/or FIG.2, and/or any portions or combinations thereof) and/or networks (e.g., the network 104 of FIG. 1), and/or any portions or combinations thereof. In some embodiments, the method 400 may be embodied in, facilitated by, and/or otherwise associated with various input mechanisms and/or interfaces such as the interfaces 220, 520 described with respect to FIG. 2, FIG. 5A, FIG. 5B, FIG. 5C, FIG. 5D, FIG. 5E, FIG. 5F, FIG. 5G, FIG. 5H, and/or FIG. 5I herein. According to some embodiments, the method 400 may comprise a method for customer-driven risk analysis.

The functional diagrams and flow diagrams described herein do not necessarily imply a fixed order to any depicted actions, steps, and/or procedures, and embodiments may generally be performed in any order that is practicable unless otherwise and specifically noted. Any of the processes and methods described herein may be performed and/or facilitated by hardware, software (including microcode), firmware, or any combination thereof. For example, a storage medium (e.g., a hard disk, Universal Serial Bus (USB) mass storage device, and/or DVD) may store thereon instructions that when executed by a machine (such as a computerized processing device) result in performance according to any one or more of the embodiments described herein.

In some embodiments, the method 400 may comprise determining injury class categorization, at 402. In the case that the method 400 is performed to facilitate customer-driven risk analysis for business insurance products such as workers' compensation insurance, for example, a plurality of known injury types and associated injury classes may be determined. It may be determined, for example, that various types of strain injuries are caused by improper and/or deficient ergonomic issues in the workplace. In such embodiments, the identified strain injury types (and/or other similarly-identified injury types; e.g., nerve damage injuries) may be assigned to and/or otherwise associated with an “ergonomic injury” classification. In some embodiments, the determining of the injury classification for any desired number and/or type of injuries may comprise conducting a mapping of the known injury types to one or more desired injury classifications. As in the example “ergonomic injury” classification, some or all of the injury classifications may comprise classifications descriptive of a cause of the underlying injury types. In some embodiments, the injury classifications may comprise different levels and/or hierarchies of classifications. The example “ergonomic injury” classification may, for example, comprise one of a plurality of sub-classes of a “preventable injury” classification. According to some embodiments, the determining and/or mapping may be conducted as a background and/or preparatory data processing procedure. In some embodiments, instructions for the determining and/or mapping may be stored and/or compiled—such as may comprise a software application and/or procedure. In some embodiments, results of the determining and/or mapping may be stored in one or more data tables, databases, and/or other data stores.

According to some embodiments, the method 400 may comprise determining a risk data summary table, at 404. Various data (e.g., as described herein) associated with a customer, a customer's business, demographics, statistics, and/or other insurance-related data may be utilized to facilitate a determination of risk exposure for a customer. In some embodiments, such data (or any portion thereof, as is or becomes desirable and/or practicable) may exist and/or reside in a plurality of data stores, formats, and/or locations and/or may require knowledge of, access to, and/or utilization of various and/or differing electronic addresses, credentials, and/or other information. In some embodiments, even if a customer had the appropriate knowledge, access, etc., the disparate and/or detailed nature of such data may require multiple complex and/or nested or iterative reports, queries, and/or analysis in order to gain an understanding of the customer's risk exposure. According to some embodiments, by creating one or more summary tables of selected portions of the available risk data associated with the customer, much of the expertise and work required to conduct a risk analysis may be completed on behalf of the customer. Summary tables may, for example, allow or permit a customer to conduct simple queries that reveal important risk analysis decision-making metrics which would otherwise be too complex and/or time-consuming for the customer to conduct. According to some embodiments, one or more summary tables may be created, accessed, and/or otherwise determined based on the injury classification (and/or mapping) conducted at 402. A summary table may, for example, summarize risk data based on the “ergonomic injury” classification (e.g., which may include data descriptive of a plurality of injury types falling into such classification).

In some embodiments, the method 400 may comprise providing a risk analysis interface, at 406. The risk analysis interface may, for example, comprise a web page, website, Graphical User Interface (GUI), mobile device application, touch-screen application and/or interface, and/or any combinations thereof. According to some embodiments, the risk analysis interface may comprise a series of screen interface screens such as the example interfaces 220, 520 described with respect to FIG. 2, FIG. 5A, FIG. 5B, FIG. 5C, FIG. 5D, FIG. 5E, FIG. 5F, FIG. 5G, FIG. 5H, and/or FIG. 5I. In some embodiments, the interface may be provided by transmitting (or causing a transmitting) of one or more signals and/or data to a device utilized by a customer/user. In some embodiments, the interface may be provided via provision of application software and/or other stored specially-programmed instructions (e.g., execution of which may cause a processing device to operate in accordance with embodiments described herein).

According to some embodiments, the method 400 may comprise receiving customer input via the risk analysis interface, at 408. A customer and/or other user may, for example, provide an indication of a customer/user selection of one or more parameters and/or metrics via the risk analysis interface provided at 406. In some embodiments, a server and/or other processing device may receive such an indication and/or input from a device operated by the customer/user. According to some embodiments, the input may comprise an identification and/or definition of metric for which data presented by the risk analysis interface is to be summarized, ranked, sorted, and/or otherwise processed and/or provided or displayed.

In some embodiments, the method 400 may comprise causing the risk analysis interface to output a risk data summarization, at 410. The input received at 408, for example, may be utilized to determine how data provided/displayed via the interface should be output, summarized, ranked, and/or selected or chosen. The causing may, in some embodiments, comprise reconfiguring the interface and/or causing a reconfigured version of the interface (or a portion thereof) to be displayed (e.g., via a mobile device operated by a customer/user). In some embodiments, the risk data summarization may comprise a summary of risk data pulled from one or more risk summarization data tables based on the input received at 408.

According to some embodiments, the method 400 may comprise providing risk exposure guidance, at 412. In some embodiments, the risk analysis interface may provide an indication of risk exposure guidance. Based on the risk data summarization at 410, for example, one or more suggestions and/or recommendations may be provided (e.g., via the risk analysis interface). According to some embodiments, the risk exposure guidance may comprise and/or define a series of steps that a customer/user should implement to attempt to reduce risk exposure of the customer (and/or a business of the customer). The guidance may comprise a definition of a safety program and/or recommendations for how an existing safety program may be altered to reduce risk exposure and/or insurance costs (e.g., based at least in part on the risk data summarization and/or trends or decisions made therefrom).

In some embodiments, the method 400 may comprise providing remedial action effectiveness analysis, at 414. Risk exposure data and/or a risk data summarization (e.g., provided by the risk analysis interface) may, for example, be analyzed to determine how one or more risk exposure metrics have changed. In some embodiments, changes in such metrics may be compared to data descriptive of risk exposure remedial actions taken by a customer to determine an effectiveness of such actions. An initial risk data summarization may be provided and/or determined at 410, for example, and the customer may take one or more corrective and/or remedial actions in response thereto (and/or in response to any risk exposure guidance provided at 412). In some embodiments, an indication of the action(s) taken by the customer may be received (and/or provided by the customer). The customer may, for example, enter data regarding safety program measures and/or dates actions have been taken. A second risk data summarization may then be provided and/or determined and compared to the initial (e.g., pre-remediation) risk data summarization. Differences between the two risk data summarizations (or other risk data metrics) may be analyzed to determine if the changes are likely to be due to any actions taken by the customer. In the case that customer actions are determined to have had an impact on risk data metrics, the extent of the change may be analyzed to determine an effectiveness of the actions. In some embodiments, the determined effectiveness may be provided to the customer via the risk analysis interface. The interface may be configured, for example, to show that a safety program implemented to address workplace slip-and-fall injury problems has reduced the numbers of such injuries (and/or claims or claim amounts) by a certain amount and/or percentage. In some embodiments, the effectiveness may be determined and/or expressed in terms of monetary savings (or effect) realized due to and/or attributable to the actions. The effectiveness may, for example, comprise an indication of an amount of savings due to decreased claims/losses and/or due to decreased insurance premiums, deductibles, etc. (e.g., realized and/or earned due to a decrease in risk exposure).

Referring now to FIG. 5A, FIG. 5B, FIG. 5C, FIG. 5D, FIG. 5E, FIG. 5F, FIG. 5G, FIG. 5H, and FIG. 5I, an example interface 520 according to some embodiments is shown. In some embodiments, the interface 520 may comprise a web page, web form, database entry form, Application Program Interface (API), spreadsheet, table, and/or application or other GUI, such as a smart phone application. The interface 520 may, for example, be utilized by a customer and may facilitate customer-driven risk analysis as described herein. The interface 520 may, for example, comprise portions of a customer-driven risk analysis application and/or platform programmed and/or otherwise configured to execute, conduct, and/or facilitate the method 400 of FIG. 4 and/or portions or combinations thereof. In some embodiments, the interfaces 520 may be output via one or more computerized devices such as the customer devices 102a-n of FIG. 1 herein.

According to some embodiments, the interface 520 (e.g., as shown in FIG. 5A), may comprise an interface screen that allows a customer to select a variety of available options. As depicted, for example, the interface 520 may provide an “e-CARMA Dashboard” that allows a customer/user to select from various categories of options such as a Red Flags Dashboard 522a, a Loss Analysis Dashboard 522b, an Executive Dashboard 522c, a Performance Dashboard 522d, and/or a Risk Analysis Dashboard 522e. In some embodiments, the interface 520 may comprise a saved customer preference option such as My Dashboard 522f. The My Dashboard 522f may, for example, provide a link to one or the other Dashboards 522a-e previously utilized and/or indicated as desirable by a customer/user. In some embodiments, selection of one or more of the specific Dashboards 522a-f may be filtered, refined, and/or narrowed, such as by selection of a particular insurance type for the Risk Analysis Dashboard 522e (e.g., Workers Compensation, General Liability, Auto, and/or Property). In some embodiments, selection of the Risk Analysis Dashboard 522e may cause another (e.g., different and/or modified) interface 520 to be displayed, generated, and/or otherwise provided.

According to some embodiments, selection of the Risk Analysis Dashboard 522e of the interface 520 of FIG. 5A may cause the interface 520 as depicted in FIG. 5B to be provided. In some embodiments, the interface 520 may comprise various drop-down menus (and/or other features) from which the customer/user may select summarization and/or filter options. The interface 520 may comprise, for example, an insurance type selector 524a, a filter level selector 524b, and/or a filter value selector 524c. The insurance type selector 524a may, according to some embodiments, comprise a drop-down menu (as depicted in FIG. 5B) that allows the customer to select one or more types of insurance for which data presented by the interface 520 may be limited, summarized, and/or filtered. As shown in the example of FIG. 5B, the insurance type selector 524a has been utilized to select “Workers Compensation” insurance. The filter level selector 524b may, in some embodiments, comprise a drop-down menu (as depicted in FIG. 5B) that allows the customer to select a level by which the data presented by the interface 520 may be limited, summarized, and/or filtered. As shown in the example of FIG. 5B, the filter level selector 524b has been utilized to select an “Entire Organization” option—e.g., as opposed to limiting the presented data to a particular level such as division, fleet, geographic area and/or location, business group, entity, and/or other business and/or logical classification. In some embodiments, the filter value selector 524c may be utilized in tandem with the filter level selection to define a filter to apply to the data presented by the interface 520. As depicted in the example of FIG. 5B, no filter value (e.g., other than perhaps the insurance type and/or organizational classification) has been selected and/or defined.

In some embodiments, the interface 520 may comprise an analysis dimension section 526 that provides tools and/or options that facilitate customer-driven risk analysis. The analysis dimension section 526 may, for example, comprise an analysis dimension selector 526a, a ranking range selector 526b, and/or an analysis metric selector 526c. The analysis dimension selector 526a may, in some embodiments, comprise a drop-down menu (as depicted in FIG. 5B) that allows a customer to select an analysis dimension via which data presented by the interface 520 is to be analyzed. As depicted in the example of FIG. 5B, “Accident Cause” has been selected as the analysis metric via which presented data is to be analyzed (e.g., ranked, sorted, summarized, filtered, and/or otherwise processed). In some embodiments, the ranking range selector 526b may allow a customer to select a range of rankings to be displayed. In the case that presented data is to be ranked (or otherwise analyzed) based on the selected “Accident Cause” dimension, for example, only the top five (5) ranked accident causes (e.g., the “Top 5”) may be shown or provided (e.g., as depicted in the example of FIG. 5B). In some embodiments, the analysis metric selector 526c may allow a customer to select a metric via which rankings (or other analysis) may be based (in whole or in part). As depicted, for example, the top five (5) accident causes are to be provided based on a count of the number of insurance claims (e.g., “Claim Count”).

According to some embodiments, the interface 520 may comprise one or more options that the customer may select to initiate one or more additional functionalities and/or to launch, create, invoke, and/or have provided one or more other screens and/or graphical elements. A Rate Trends option 528a may, for example, allow a customer to view a trend of the customer's risk exposure over time. In some embodiments, a Preferences option 528b may allow a customer to select, identify, and/or define one or more preferences via which the interface 520 is configured and/or a Create PDF option 528c may be utilized to create PDF images (and/or other document and/or image formats) for selected portions of the interface 520.

In some embodiments for example, the interface 520 may comprise one or more portions via which specific types of risk analysis data are presented. The interface 520 may comprise, for example, a chart portion 530 (e.g., a first portion), a trend portion 532 (e.g., a second portion), and/or a detail portion 534 (e.g., a third portion). In some embodiments, the chart portion 530 may provide a risk exposure chart 530-1 of the risk data associated with the customer. As depicted in FIG. 5B, the risk exposure chart 530-1 may be set, via a data range selector 530-2, to be based on data for one or more specific time periods. Also as depicted in FIG. 5B, as the risk exposure chart 530-1 may be limited to a subset of risk data (e.g., top five (5) accident causes, as defined by the analysis selection section 526), the chart portion 530 may comprise a data relevance indicator 530-3 that provides an indication of what percentage of the total available data is currently being viewed via the chart section 530 and/or via the interface 520 (e.g., seventy-three percent (73%) as depicted in the example of FIG. 5B). The chart portion 530 may, for example, allow a customer to quickly and/or easily identify which risk metrics are the largest contributors to the customer's risk exposure. In the example of FIG. 5B, a customer would be able to easily determine (e.g., via the risk exposure chart 530-1) that “Cut/Puncture” accident causes (e.g., injury classifications) are the largest contributing type of workers compensation claims experienced by the customer.

In some embodiments, the trend portion 532 may comprise a Trend Analysis tab 532a and/or an Organization Analysis tab 532b. As shown in FIG. 5B, the Trend Analysis tab 532a may provide a risk trend graph 532a-1. According to some embodiments, the risk trend graph 532a-1 may provide trend data for any one of the particular accident causes selected from the chart portion 530. As depicted in FIG. 5B, for example, the customer has chosen (e.g., indicated by the removed pie-portion from the risk exposure chart 530-1) the “Cut/Puncture” accident cause. Based on such a selection, in some embodiments, the risk trend graph 532a-1 may provide trend data for “Cut/Puncture” accident cause workers compensation insurance claims. In some embodiments, the Trend Analysis tab 532a and/or the trend portion 532 may allow a customer to quickly and/or easily determine (e.g., for particular risk metrics selected in the chart portion 530) whether risk exposure problems for a particular risk metric are increasing, decreasing, or staying the same (e.g., determine a trend). In the example of FIG. 5B, a customer would be able to easily determine that while “Cut/Puncture” accident causes are the leading contributor to workers compensation insurance claims, the number of such claims has been trending downward for several years.

According to some embodiments, the detail portion 534 may provide detailed data regarding one or more risk metrics. The detail portion 534, for example, may provide detailed data descriptive of contributing factors to the “Cut/Puncture” accident type selected in either or both of the chart portion 530 and/or the trend portion 532. As depicted in FIG. 5B, the detail portion 534 may summarize various metrics detailing the selected accident cause (or other risk metric)—e.g., average length of employment for those employees having reported a “Cut/Puncture” workers compensation insurance injury claim, employee age data, and/or lost work days (e.g., total or average).

The interface 520 as depicted in FIG. 5C provides a more detailed example of the analysis metric selector 526a. As shown in FIG. 5C, for example, the customer may choose to have the risk data presented by the interface 520 ranked based on the “Accident Cause” selected in the example of FIG. 5B, by “Accident Result”, “Part of the Body”, “Ergonomics”, and/or various different organizational groups, departments, etc. In such a manner, the customer may easily and/or quickly identify which risk metrics are the largest contributors to the customer's risk exposure—e.g., those areas of risk that may (or should) be addressed in an attempt to reduce the customer's risk exposure and/or insurance costs.

The interface 520 as depicted in FIG. 5D provides a more detailed example of the Organization Analysis tab 532b. As shown in FIG. 5D, for example, the risk data breakdown amongst various business and/or organizational units, departments, etc. for a particular risk metric (e.g., a particular “Accident Cause”) may be provided. In the example of FIG. 5D, the customer would be able to easily identify “District 2” as the leading contributor to workers compensation claims for the selected accident cause and also easily identify that “District 4” is the leading contributor to total value of such insurance claims made. In some embodiments, the customer may be able to “drill-down” into various portions or sections of data provided by the interface 520. Customer selection of the “District 4” record in the Organization Analysis tab 532b of the trend section 532, for example, may cause another (e.g., different and/or modified) interface 520 to be displayed, generated, and/or otherwise provided.

According to some embodiments, selection of a metric (e.g. “Average Age”) in 534 and selection of a record (e.g., the “District 4” record) in the Organization Analysis tab 532b of the interface 520 of FIG. 5D may cause the interface 520 as depicted in FIG. 5E to be provided. The interface 520 depicted in FIG. 5E may, for example, comprise a data detail window 536. In some embodiments, the data detail window 536 may comprise a detail chart 536-1 (e.g., as depicted in FIG. 5E). The detail chart 536-1 may, for example, show the distribution of claims for the specific district (e.g., “District 4”) as it relates to the selected metric selected from the interface 520 as depicted in FIG. 5D and/or FIG. 5E.

In some embodiments, the various options 528a-c shown on the interface 520 may, as noted supra, cause one or more pop-up menus, windows, screens, and/or other forms of additional functionality to be presented. In the case that the Rate Trends option 528a of FIG. 5B is selected by a customer, for example, a Rate Trends window 528a-1 as depicted in FIG. 5F may be provided. The Rate Trends window 528a-1 may, for example, comprise a Rate Trends graph 528a-2 and/or a Rate Trends toolbar 528a-3. In some embodiments, the Rate Trends toolbar 528a-3 may allow a customer to adjust (e.g., fine-tune) the output of the Rate Trends graph 528a-2 such as by selecting a valuation period (e.g., twelve (12) months as shown), a drill-down level (e.g., “All States”, “All Regions”, or specific States, Regions, Divisions, groups, etc.), and/or whether the displayed rate comprises a frequency rate or a loss rate.

According to some embodiments, the Preferences option 528b of FIG. 5B may be selected to cause provision of a Preferences window 538. The Preferences window 538 may, for example, comprise various portions and/or features that allow the customer to select, identify, define, and/or otherwise determine and/or save one or more preferences. As depicted in FIG. 5G, for example, the Preferences window 538 may comprise a General tab 538a that allows the customer to set various general preferences such as the manner in which date ranges and/or periods should be determined (e.g., based on policy effective dates or custom defined dates, as shown) for data presented via the interface 520. In some embodiments, the Preferences window 538 may comprise a Limiting tab 538b. As shown in more detail in FIG. 5H, for example, the Limiting tab 538b may comprise one or more filter (or limit) definition options 538b-1 that allow the customer to set limits on and/or filter the data presented via the interface 520.

In some embodiments, the Create PDF option 528c of FIG. 5B may be selected to cause a file creation and/or print selection menu 528c-1 to be provided, as shown in the example of FIG. 5I. The print selection menu 528c-1 may, for example, comprise one or more print selection options 528c-2 that allow the customer to selectively define which portions (e.g., the portions 530, 532, 534) of the interface 520 are to be printed (e.g., to file, hard copy, faxed, e-mailed, etc.). In some embodiments, such as depicted in FIG. 5I, certain portions of the interface 520 may not be selected and accordingly may not, upon execution of a print job in accordance with the preferences defined by the print selection menu 528c-1, be sent to a selected printer (e.g., a PDF print driver). In such a manner, only those portions of the interface 520 that are desired to be printed may be identified and sent to the printer. In some embodiments, each such portion of the interface 520 may be sent to the printer as a full-screen and/or full-page print job.

While various components of the interface 520 have been described with respect to certain labels, layouts, headings, windows, tabs, pages, titles, and/or configurations, these features have been presented for reference and example only. Other labels, layouts, headings, windows, tabs, pages, titles, and/or configurations may be implemented without deviating from the scope of embodiments herein. Similarly, while a certain number and/or type of windows, tabs, information screens, form fields, data types, graphical elements, and/or data entry options have been presented, variations thereof may be practiced in accordance with some embodiments. In some embodiments, the interface 520 may comprise one or more links to other web pages, web sites, and/or other external data. Such data may, for example, be contextually provided and/or determined based on portions of the interface 520 interacted with and/or viewed by a customer. In some embodiments, such data may comprise various guidelines, reference material, training material, and/or other guidance regarding reduction of risk exposure (e.g., with respect to specific accident causes and/or other metrics or dimensions selected by the customer via the interface 520).

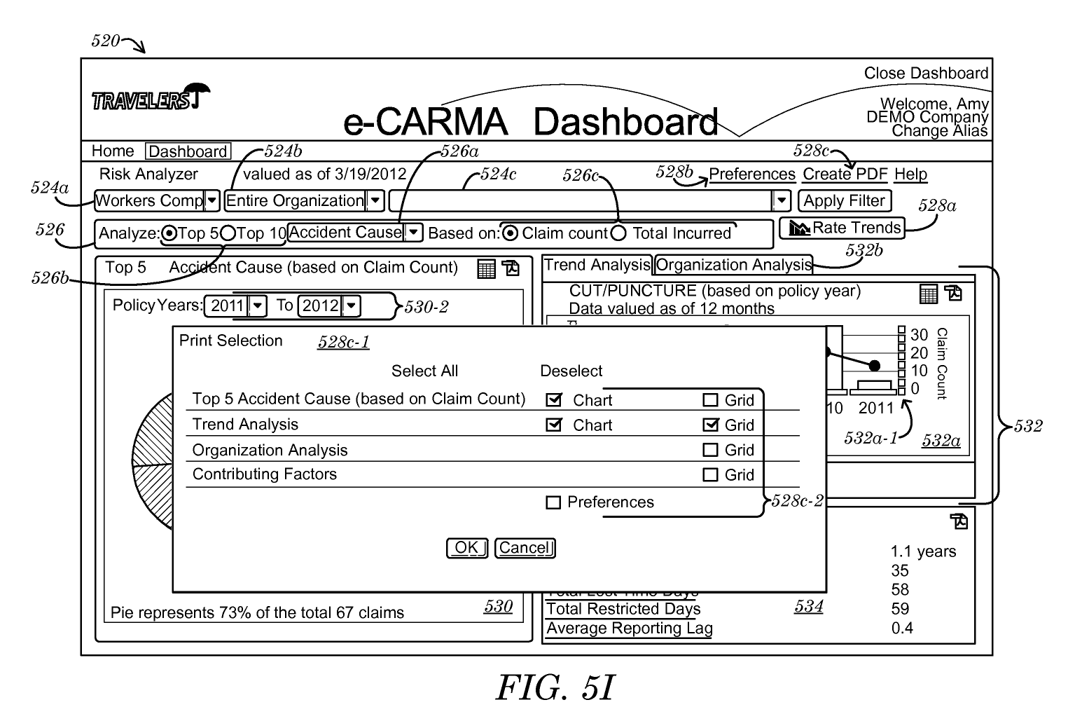

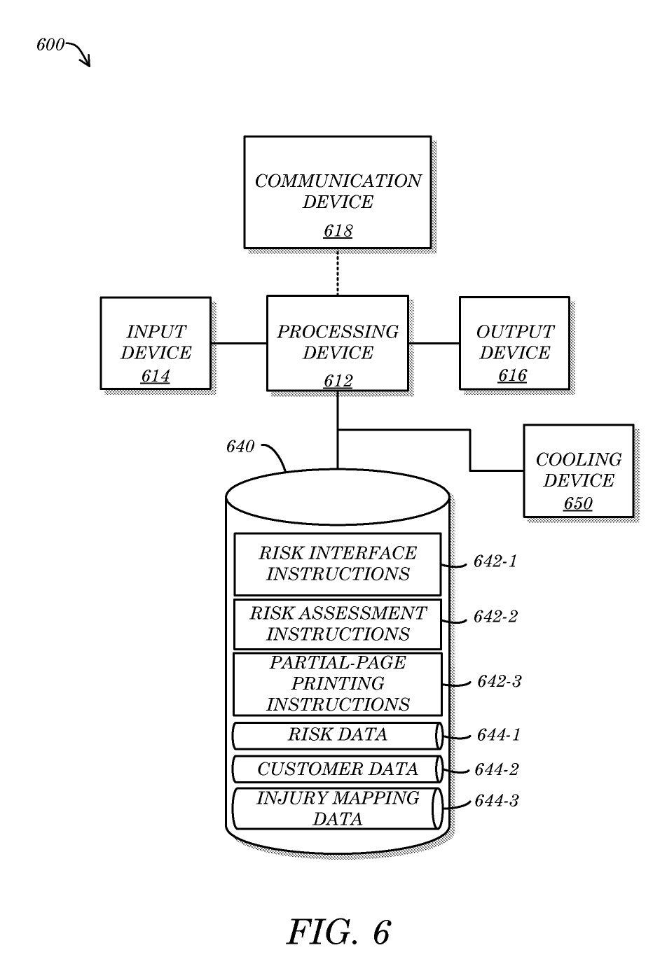

Turning to FIG. 6, a block diagram of an apparatus 600 according to some embodiments is shown. In some embodiments, the apparatus 600 may be similar in configuration and/or functionality to any of the customer devices 102a-n and/or the risk analysis server 110 of FIG. 1 and/or may comprise a portion of the system 200 of FIG. 2 herein. The apparatus 600 may, for example, execute, process, facilitate, and/or otherwise be associated with the method 400 described in conjunction with FIG. 4 herein. In some embodiments, the apparatus 600 may comprise a processing device 612, an input device 614, an output device 616, a communication device 618, and/or a memory device 640. According to some embodiments, any or all of the components 612, 614, 616, 618, 640 of the apparatus 600 may be similar in configuration and/or functionality to any similarly named and/or numbered components described herein. Fewer or more components 612, 614, 616, 618, 640 and/or various configurations of the components 612, 614, 616, 618, 640 may be included in the apparatus 600 without deviating from the scope of embodiments described herein.

According to some embodiments, the processing device 612 may be or include any type, quantity, and/or configuration of electronic and/or computerized processor that is or becomes known. The processing device 612 may comprise, for example, an Intel® IXP 2800 network processor or an Intel® XEON™ Processor coupled with an Intel® E7501 chipset. In some embodiments, the processing device 612 may comprise multiple inter-connected processors, microprocessors, and/or micro-engines. According to some embodiments, the processing device 612 (and/or the apparatus 600 and/or portions thereof) may be supplied power via a power supply (not shown) such as a battery, an Alternating Current (AC) source, a Direct Current (DC) source, an AC/DC adapter, solar cells, and/or an inertial generator. In the case that the apparatus 600 comprises a server such as a blade server, necessary power may be supplied via a standard AC outlet, power strip, surge protector, and/or Uninterruptible Power Supply (UPS) device.

In some embodiments, the input device 614 and/or the output device 616 are communicatively coupled to the processing device 612 (e.g., via wired and/or wireless connections and/or pathways) and they may generally comprise any types or configurations of input and output components and/or devices that are or become known, respectively. The input device 614 may comprise, for example, a keyboard that allows an operator of the apparatus 600 to interface with the apparatus 600 (e.g., by a consumer, such as to conduct a customer-driven risk analysis). In some embodiments, the input device 614 may comprise a sensor configured to provide information such as encoded risk data to the apparatus 600 and/or the processing device 612. The output device 616 may, according to some embodiments, comprise a display screen and/or other practicable output component and/or device. The output device 616 may, for example, provide a risk analysis interface to a customer (e.g., via a website). According to some embodiments, the input device 614 and/or the output device 616 may comprise and/or be embodied in a single device such as a touch-screen monitor.

In some embodiments, the communication device 618 may comprise any type or configuration of communication device that is or becomes known or practicable. The communication device 618 may, for example, comprise a network interface card (NIC), a telephonic device, a cellular network device, a router, a hub, a modem, and/or a communications port or cable. In some embodiments, the communication device 618 may be coupled to provide data to a customer device (not shown in FIG. 6), such as in the case that the apparatus 600 is utilized to provide a risk analysis interface to a customer as described herein. The communication device 618 may, for example, comprise a cellular telephone network transmission device that sends signals indicative of risk interface components to customer and/or subscriber handheld, mobile, and/or telephone device. According to some embodiments, the communication device 618 may also or alternatively be coupled to the processing device 612. In some embodiments, the communication device 618 may comprise an IR, RF, Bluetooth™, and/or Wi-Fi® network device coupled to facilitate communications between the processing device 612 and another device (such as a customer device and/or a third-party device).

The memory device 640 may comprise any appropriate information storage device that is or becomes known or available, including, but not limited to, units and/or combinations of magnetic storage devices (e.g., a hard disk drive), optical storage devices, and/or semiconductor memory devices such as RAM devices, Read Only Memory (ROM) devices, Single Data Rate Random Access Memory (SDR-RAM), Double Data Rate Random Access Memory (DDR-RAM), and/or Programmable Read Only Memory (PROM). The memory device 640 may, according to some embodiments, store one or more of risk interface instructions 642-1, risk assessment instructions 642-2, partial-page printing instructions 642-3, risk data 644-1, customer data 644-2, and/or injury mapping data 644-3. In some embodiments, the risk interface instructions 642-1, risk assessment instructions 642-2, partial-page printing instructions 642-3 may be utilized by the processing device 612 to provide output information via the output device 616 and/or the communication device 618 (e.g., the risk analysis interface at 406 and/or the risk exposure guidance at 412 of the method 400 of FIG. 4).

According to some embodiments, the risk interface instructions 642-1 may be operable to cause the processing device 612 to process risk data 644-1, customer data 644-2, and/or injury mapping data 644-3. Risk data 644-1, customer data 644-2, and/or injury mapping data 644-3 received via the input device 614 and/or the communication device 618 may, for example, be analyzed, sorted, filtered, decoded, decompressed, ranked, scored, plotted, and/or otherwise processed by the processing device 612 in accordance with the risk interface instructions 642-1. In some embodiments, risk data 644-1, customer data 644-2, and/or injury mapping data 644-3 may be fed by the processing device 612 through one or more mathematical and/or statistical formulas and/or models in accordance with the risk interface instructions 642-1 to define one or more injury classification mappings, provide a risk analysis interface, and/or provide risk exposure guidance and/or feedback, in accordance with embodiments described herein.

In some embodiments, the risk assessment instructions 642-2 may be operable to cause the processing device 612 to process risk data 644-1, customer data 644-2, and/or injury mapping data 644-3. Risk data 644-1, customer data 644-2, and/or injury mapping data 644-3 received via the input device 614 and/or the communication device 618 may, for example, be analyzed, sorted, filtered, decoded, decompressed, ranked, scored, plotted, and/or otherwise processed by the processing device 612 in accordance with the risk assessment instructions 642-2. In some embodiments, risk data 644-1, customer data 644-2, and/or injury mapping data 644-3 may be fed by the processing device 612 through one or more mathematical and/or statistical formulas and/or models in accordance with the risk assessment instructions 642-2 to define one or more injury classification mappings, provide a risk analysis interface, and/or provide risk exposure guidance and/or feedback, in accordance with embodiments described herein.

According to some embodiments, the partial-page printing instructions 642-3 may be operable to cause the processing device 612 to initiate a printing of one or more sub-sections and/or potions of a displayed screen and/or interface. The partial-page printing instructions 642-3 may, for example, cause the output device 616 (e.g., a printer) and/or the communication device 618 to cause a printing (and/or file creation) of customer-designated portions of a risk analysis interface.

Any or all of the exemplary instructions and data types described herein and other practicable types of data may be stored in any number, type, and/or configuration of memory devices that is or becomes known. The memory device 640 may, for example, comprise one or more data tables or files, databases, table spaces, registers, and/or other storage structures. In some embodiments, multiple databases and/or storage structures (and/or multiple memory devices 640) may be utilized to store information associated with the apparatus 600. According to some embodiments, the memory device 640 may be incorporated into and/or otherwise coupled to the apparatus 600 (e.g., as shown) or may simply be accessible to the apparatus 600 (e.g., externally located and/or situated).

In some embodiments, the apparatus 600 may comprise a cooling device 650. According to some embodiments, the cooling device 650 may be coupled (physically, thermally, and/or electrically) to the processing device 612 and/or to the memory device 640. The cooling device 650 may, for example, comprise a fan, heat sink, heat pipe, radiator, cold plate, and/or other cooling component or device or combinations thereof, configured to remove heat from portions or components of the apparatus 600.

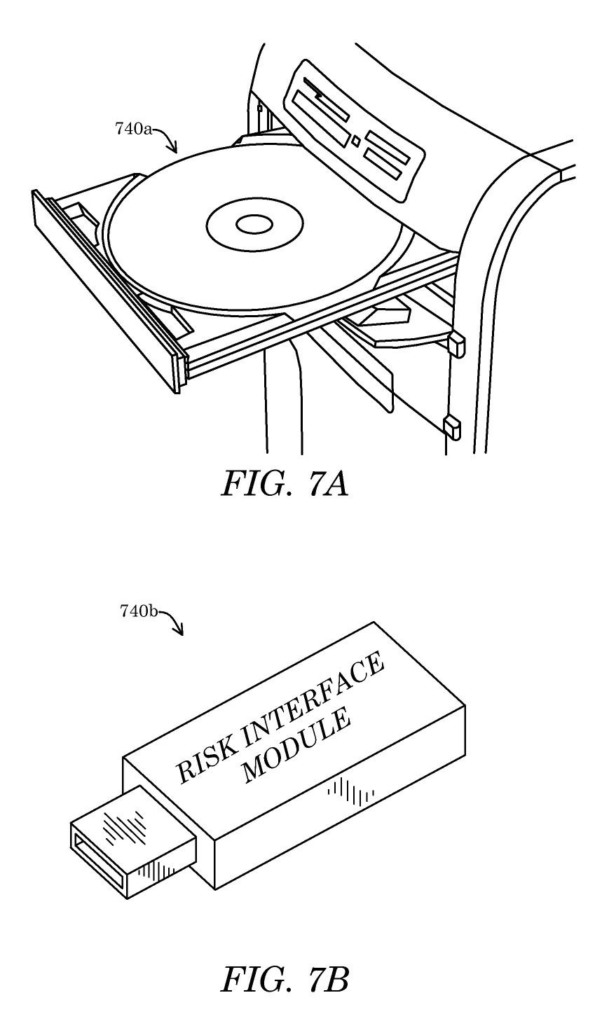

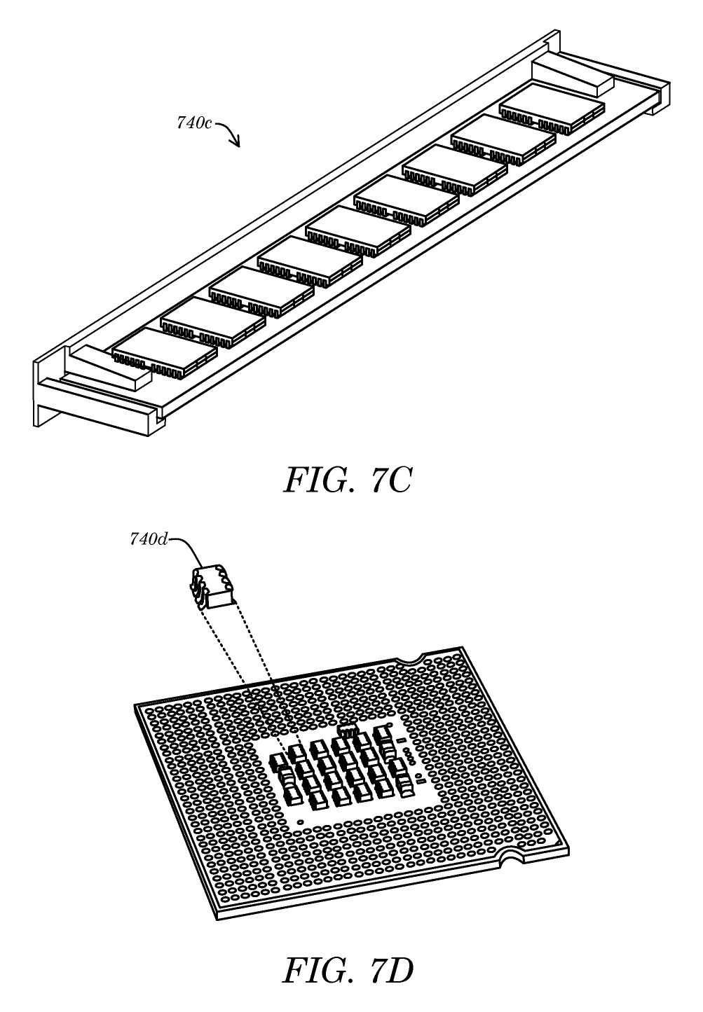

Referring now to FIG. 7A, FIG. 7B, FIG. 7C, and FIG. 7D, perspective diagrams of exemplary data storage devices 740a-d according to some embodiments are shown. The data storage devices 740a-d may, for example, be utilized to store instructions and/or data such as the risk interface instructions 642-1, risk assessment instructions 642-2, partial-page printing instructions 642-3, risk data 644-1, customer data 644-2, and/or injury mapping data 644-3, each of which is described in reference to FIG. 6 herein. In some embodiments, instructions stored on the data storage devices 740a-d may, when executed by a processor (such as the electronic processor 612 of FIG. 6), cause the implementation of and/or facilitate the method 400 described in conjunction with FIG. 4, and/or portions thereof, as described herein.

According to some embodiments, the first data storage device 740a may comprise a CD, CD-ROM, DVD, Blu-Ray™ Disc, and/or other type of optically-encoded disk and/or other computer-readable storage medium that is or becomes know or practicable. In some embodiments, the second data storage device 740b may comprise a USB keyfob, dongle, and/or other type of flash memory data storage device that is or becomes know or practicable. According to some embodiments, the third data storage device 740c may comprise RAM of any type, quantity, and/or configuration that is or becomes practicable and/or desirable. In some embodiments, the third data storage device 740c may comprise an off-chip cache such as a Level 2 (L2) or Level 3 (L3) cache memory device. According to some embodiments, the fourth data storage device 740d may comprise an on-chip memory device such as a Level 1 (L1) cache memory device.

The data storage devices 740a-d may generally store program instructions, code, and/or modules that, when executed by an electronic and/or computerized processing device cause a particular machine to function in accordance with embodiments described herein. In some embodiments, the data storage devices 740a-d depicted in FIG. 7A, FIG. 7B, FIG. 7C, and FIG. 7D are representative of a class and/or subset of computer-readable media that are defined herein as “computer-readable memory” (e.g., memory devices as opposed to transmission devices). While computer-readable media may include transitory media types, as utilized herein, the term computer-readable memory is limited to non-transitory computer-readable media.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

What is claimed is:

1. A method, comprising:
determining, by a processing device, which one injury class of a plurality of injury classes an injury type is categorized in;
creating, by the processing device, a summary data table storing aggregated risk data for a customer, the summary data table including an indication of the categorization of the injury type to the one injury class of the plurality of injury classes;
providing, by the processing device, an interface comprising one or more graphical representations of the aggregated risk data for the customer;
receiving, by the processing device, an indication of customer input identifying a risk data summary metric; and
causing, by the processing device, the interface to display at least one portion of the aggregated risk data summarized by the identified risk data summary metric.

2. The method of claim 1, further comprising:
providing, based on the at least one portion of the aggregated risk data summarized by the identified risk data summary metric, risk exposure reduction guidance.

3. The method of claim 2, further comprising:
determining, after the providing of the risk exposure reduction guidance, that a risk exposure remedial action is taken by the customer.

4. The method of claim 3, further comprising:
causing the interface to display a representation of an effect of the risk exposure remedial action on the aggregated risk data for the customer.

5. The method of claim 1, further comprising:
determining that the customer has utilized the aggregated risk data for the customer.

6. The method of claim 5, wherein the determining that the customer has utilized the aggregated risk data for the customer comprises determining that the customer has utilized the interface.

7. The method of claim 5, further comprising:
altering, based on the determining that the customer has utilized the aggregated risk data for the customer, an insurance payment of the customer.

8. The method of claim 7, wherein the insurance payment comprises one or more of: (i) an insurance premium; (ii) an insurance deductible; and (iii) an insurance discount.

9. The method of claim 1, wherein the determining of the one injury class of the plurality of injury classes the injury type is categorized in comprises mapping a plurality of known injury types to the plurality of injury classes.

10. The method of claim 1, wherein the risk data for the customer is aggregated based on one or more of the injury type, the at least one injury class of the plurality of injury classes, and information defining one or more divisions of a business of the customer.

11. The method of claim 1, wherein the providing of the interface comprises providing the interface via a mobile device of the customer.

12. The method of claim 1, wherein the interface comprises a first portion displaying a chart of a portion of the aggregated risk data for the customer, a second portion comprising a graphical representation of a trend descriptive of the portion of the aggregated risk data for the customer, and a third portion comprising a graphical representation of detail data from which the portion of the aggregated risk data for the customer is derived.

13. The method of claim 12, further comprising:
causing an outputting of only two of the first, second, and third portions of the interface.

14. The method of claim 13, wherein the causing of the outputting is conducted in response to an indication of an output preference of the customer.

15. The method of claim 13, wherein the outputting comprises at least one of a printing and a file creation.

16. The method of claim 13, wherein the outputting comprises a bundling of the only two of the first, second, and third portions of the interface.

17. An apparatus, comprising:
a processor; and
a memory in communication with the processor, the memory storing instructions that when executed by the processor result in:
determining which one injury class of a plurality of injury classes an injury type is categorized in;
creating a summary data table storing aggregated risk data for a customer, the summary data table including an indication of the categorization of the injury type to the one injury class of the plurality of injury classes;
providing an interface comprising one or more graphical representations of the aggregated risk data for the customer;
receiving an indication of customer input identifying a risk data summary metric; and
causing the interface to display at least one portion of the aggregated risk data summarized by the identified risk data summary metric.

18. The apparatus of claim 17, wherein the instructions, when executed by the processor, further result in:
providing, based on the at least one portion of the aggregated risk data summarized by the identified risk data summary metric, risk exposure reduction guidance.

19. The apparatus of claim 18, wherein the instructions, when executed by the processor, further result in:
determining, after the providing of the risk exposure reduction guidance, that a risk exposure remedial action is taken by the customer.

20. The apparatus of claim 19, wherein the instructions, when executed by the processor, further result in:
causing the interface to display a representation of an effect of the risk exposure remedial action on the aggregated risk data for the customer.

21. The apparatus of claim 17, wherein the instructions, when executed by the processor, further result in:
determining that the customer has utilized the aggregated risk data for the customer.

22. The apparatus of claim 21, wherein the determining that the customer has utilized the aggregated risk data for the customer comprises determining that the customer has utilized the interface.

23. The apparatus of claim 21, wherein the instructions, when executed by the processor, further result in:
altering, based on the determining that the customer has utilized the aggregated risk data for the customer, an insurance payment of the customer.

24. The apparatus of claim 23, wherein the insurance payment comprises one or more of: (i) an insurance premium; (ii) an insurance deductible; and (iii) an insurance discount.

25. An article of manufacture comprising a computer-readable memory storing instructions that when executed by a processor result in:
determining which one injury class of a plurality of injury classes an injury type is categorized in;
creating a summary data table storing aggregated risk data for a customer, the summary data table including an indication of the categorization of the injury type to the one injury class of the plurality of injury classes;
providing an interface comprising one or more graphical representations of the aggregated risk data for the customer;
receiving an indication of customer input identifying a risk data summary metric; and
causing the interface to display at least one portion of the aggregated risk data summarized by the identified risk data summary metric.
